(19) United States
(12) Patent Application Publication
(10) Pub. No.: US 2002/0147035 A1
(43) Pub. Date: Oct. 10, 2002

(54) Multifunctional battery box of a mobile telephone

(76) Inventor: Den-Tsai Su, Taipei Hsien (TW)

Correspondence Address: Keith Kline, PRO-TECHTOR INTERNATIONAl SERVICES, 20775 Norada Court, Saratoga, CA, 95070-3018, US

(21) Appl. No.: 09/835,717

(22) Filed: Apr. 10, 2001

(51) Int. Cl. H04M 1/00; H04B 1/38

(52) U.S. Cl. 455/572; 455/573; 455/550; 455/90; 320/106

(57) ABSTRACT

The present invention relates to a multifunctional battery box of a mobile telephone, especially to a battery box of a wireless mobile telephone, which includes a function of a hand-free receiver, a MP3 propagation function, a FM audio receiving function, a digital recording function, and a dialogue function, so that the mobile telephone is integrated to have utility functions. The residual space in the battery box is installed with a control circuit board including a microprocessor, a FM modulator, a digital audio processor, and a memory. The surface of the battery box is mounted with a push button set, a horn, a microphone, a USB receptacle (or RS232 receptacle), an earphone seat, and a memory expansion insertion slot, thereby forming a multifunctional battery box of a mobile telephone.

### BACKGROUND OF THE INVENTION

1. Field of the Invention

The present invention relates to a multifunctional battery box of a mobile telephone (or cellular phone), and more particularly to a battery box that is integrated to have a MP3 propagation function, a FM audio receiving function, a hand-free receiver, a digital recording function, and a dialogue function, thereby providing utility functions.

2. Description of the Related Art

A conventional wireless mobile telephone in accordance with the prior art includes a battery box whose inside has a residual space that may be provided with a circuit board and a horn, whereby the mobile telephone has a hand-free receiver, such that the user's hand needs not to hold the mobile telephone. However, the conventional mobile telephone cannot provide other functions, such as a MP3 propagation function, a FM audio receiving function, or a digital recording function, thereby limiting the utility of the conventional mobile telephone.

### SUMMARY OF THE INVENTION

The primary objective of the present invention is to provide a multifunctional battery box of a mobile telephone, especially to a battery box of a wireless mobile telephone, which includes a function of a hand-free receiver, a MP3 propagation function, a FM audio receiving function, a digital recording function, and a dialogue function, so that the mobile telephone is integrated to have utility functions. The residual space in the battery box may be installed with a control circuit board including a microprocessor, a FM modulator, a digital audio processor, and a memory. The surface of the battery box is mounted with a push button set, a horn, a microphone, a USB receptacle (or RS232 receptacle), an earphone seat, and a memory expansion insertion slot, thereby forming a multifunctional battery box of a mobile telephone.

In accordance with the present invention, there is provided a multifunctional battery box of a mobile telephone comprising:

a battery set;

a control circuit board, provided with a microprocessor, a digital audio processor, and a memory, thereby forming a function of a hand-free receiver, a MP3 propagation function, a FM audio receiving function, a digital recording function, and a dialogue function;

a push button set, mounted on a surface of the battery box, and connected to the microprocessor;

a microphone and a horn, mounted on the surface of the battery box, for providing input and output of an audio signal; and

a display, mounted on the surface of the battery box.

Preferably, the display is a digital display or a liquid crystal display.

The multifunctional battery box also comprises a memory expansion insertion slot for allowing a selective insertion of a memory card or cassette, so as to expand storage contents.

The multifunctional battery box also comprises a USB receptacle mounted on the surface of the battery box, for connection with a computer to download MP3 music into the battery box.

Alternatively, the USB receptacle mounted on the surface of the battery box may be a RS232 receptacle, for connection with a computer.

The multifunctional battery box also comprises a channel selection button mounted on the surface of the battery box, and a FM modulation integrated circuit mounted on the control circuit board.

Preferably, the memory includes a flash memory, a program memory, and a read-only memory.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a multifunctional battery box of a mobile telephone in accordance with the present invention;

FIG. 2 is a circuit diagram of the multifunctional battery box of a mobile telephone as shown in FIG. 1;

FIG. 3 is a circuit diagram of the multifunctional battery box of a mobile telephone as shown in FIG. 1;

FIG. 4 is a circuit diagram of the multifunctional battery box of a mobile telephone as shown in FIG. 1; and

FIG. 5 is a circuit diagram of the multifunctional battery box of a mobile telephone as shown in FIG. 1.

### DETAILED DESCRIPTION OF THE INVENTION

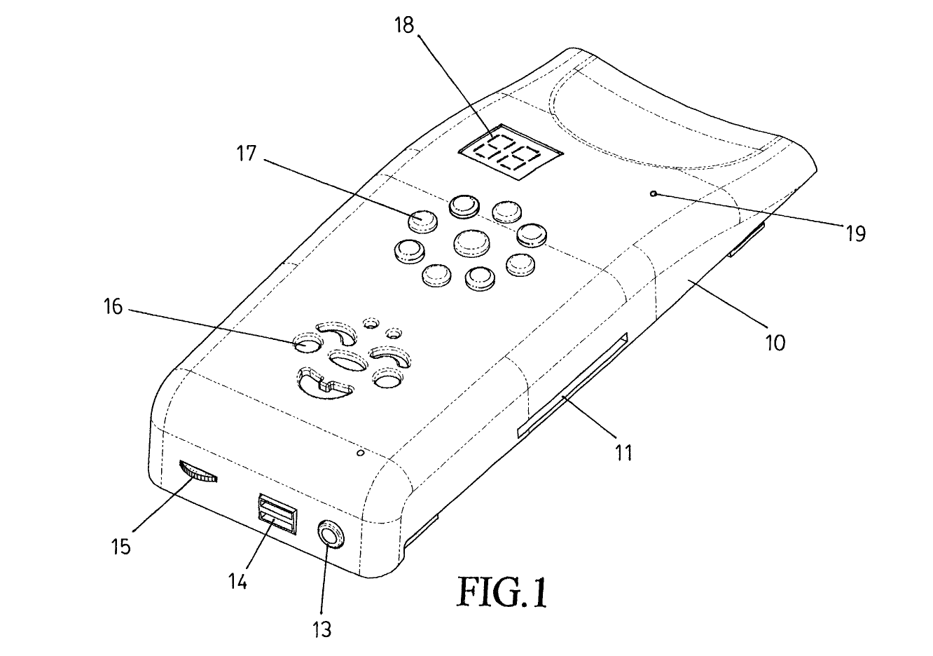

Referring to the drawings and initially to FIG. 1, a multifunctional battery box 10 of a mobile telephone (or cellular phone) in accordance with the present invention is integrated to have a MP3 propagation function, a FM audio receiving function, a hand-free receiver, a digital recording function, and a dialogue function, thereby providing utility functions.

The inside of the battery box 10 is matingly provided with a control circuit board, a microprocessor, a digital audio processor, FM modulation chips, and a memory, and co-operates with a microphone 19, an earphone seat 13, and a horn 16, thereby forming a function having a hand-free receiver, and co-operates with a digital display 18, push buttons 17, a USB receptacle 14 (or RS232 receptacle), and a memory expansion insertion slot 11, thereby forming a MP3 recorder and dialogue recorder. The USB receptacle 14 or the RS232 receptacle may be connected to the computer, to download the MP3 music into the memory of the battery box. The USB receptacle 14 may also provide another path for charging the battery box 10. When the memory built in the battery box 10 is insufficient, a card or cassette type memory having a mating specification, such as SM card, CF card, MMC card, or micro-type hard disk, may be inserted into the memory expansion insertion slot 11, so that the battery box 10 can store more MP3 music, and can provide a long-term recording function. In addition, the battery box 10 co-operating with a channel selection button 15 can provide the function of a FM channel selection radio, thereby integrating and forming the battery box 10 into a portable battery box having utility functions.

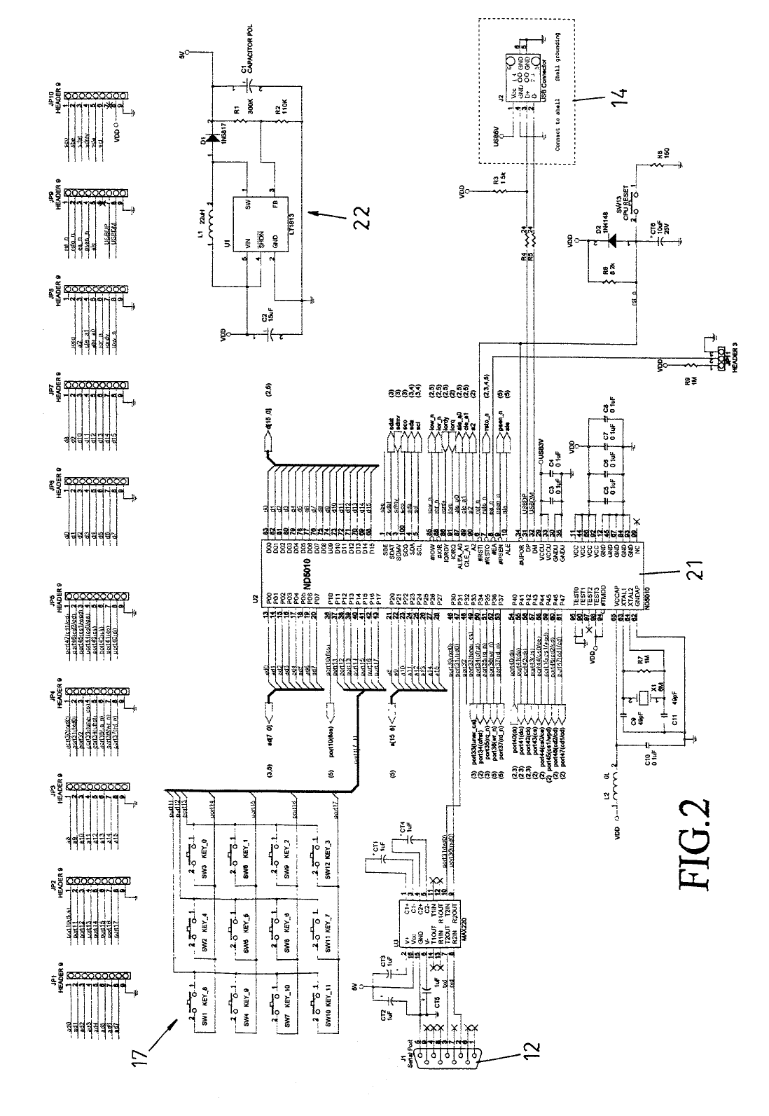

Referring to FIG. 2, the microprocessor 21 functions as the control center, and includes input and output terminals directly connected to the USB receptacle 14 (or RS232 receptacle), and the matrix push button 17, and is connected to a power circuit 22 for providing a stable voltage into the battery box 10.

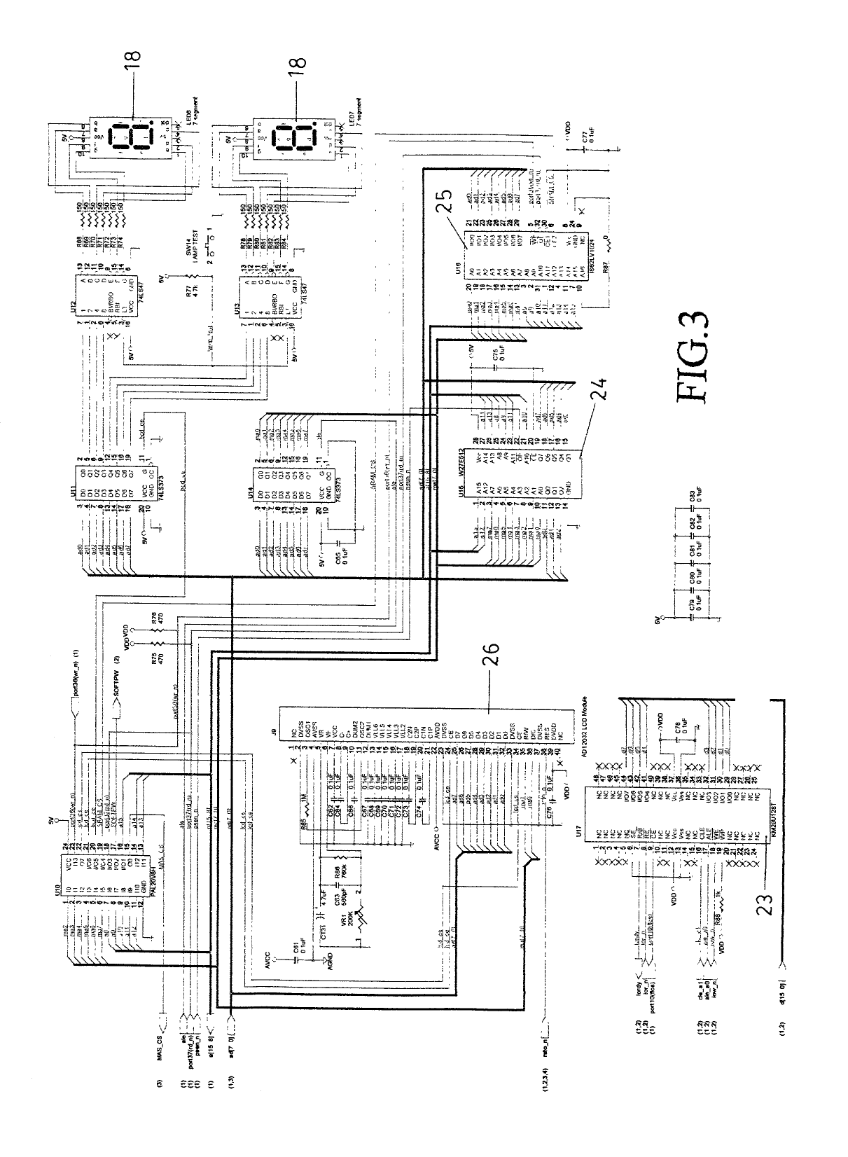

FIG. 3 shows a flash memory 23 for storing the MP3 music, a read-only memory 24 for storing the MP3 program, a static memory 25 for use of the system, an LCD connector 26 that may be selectively connected to an LCD display, and a digital display 18 connected to a decoder.

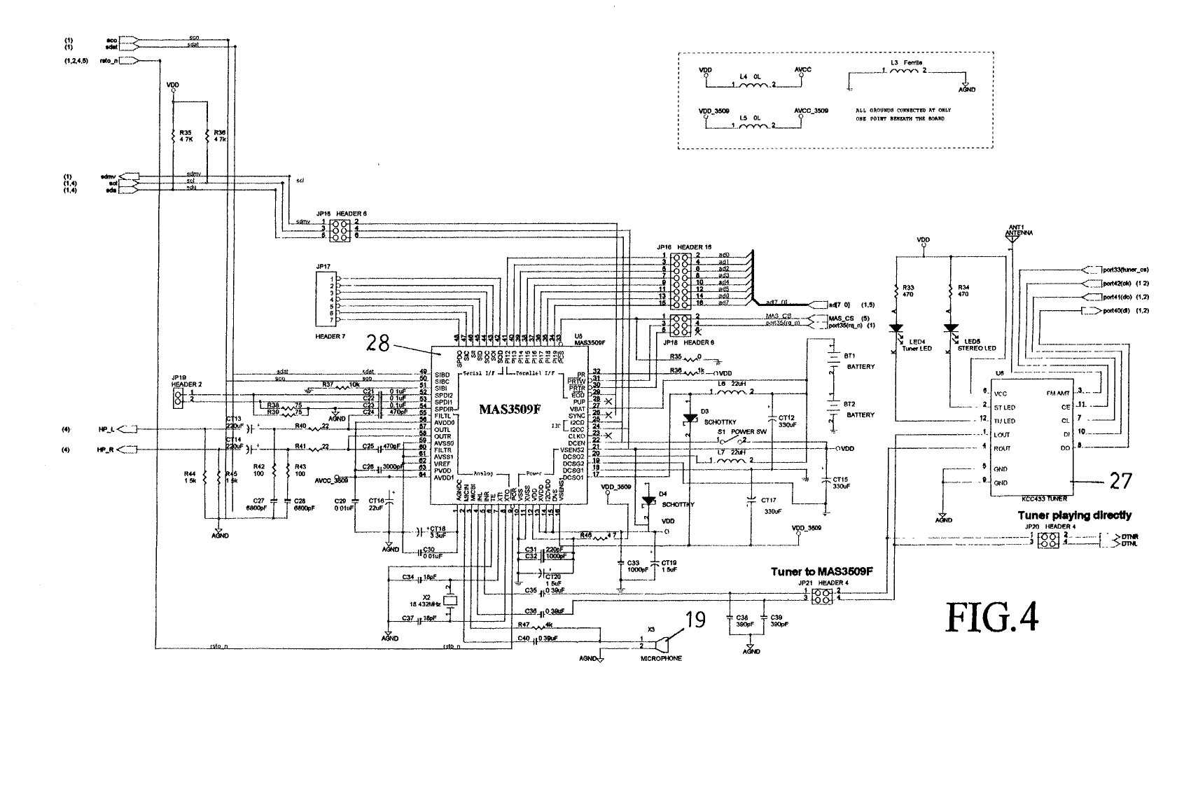

FIG. 4 shows a FM modulator 27, and an audio processor 28. The FM modulator 27 can provide the FM audio receiving function. The audio signal that has been decoded is sent into the audio processor 28 to be processed by magnification, and is then broadcast by the horn 16. The audio processor 28 has a dual function including the MP3 compression release function and the digital recording function, to co-operate with the microprocessor 21 and the flash memory 23, thereby forming a MP3 propagation function, a FM audio receiving function, a digital recording function, and a dialogue recording function.

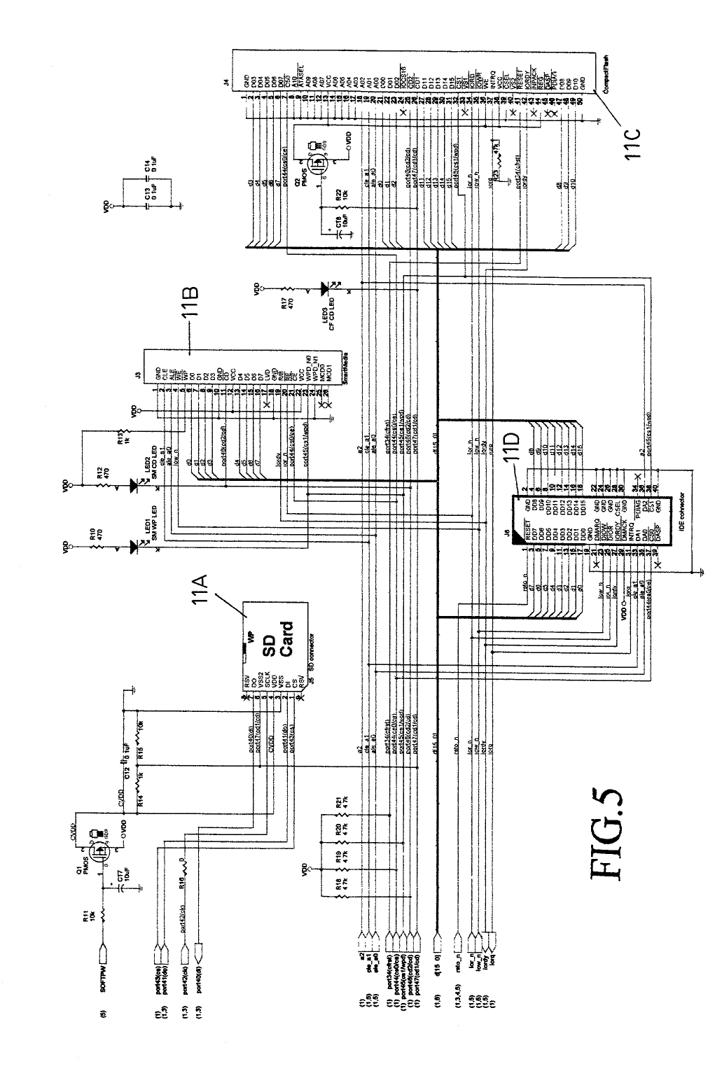

FIG. 5 shows the interface type of the memory expansion insertion slot 11, including the memory expansion interface of a MMC card receptacle 11A, a SM card receptacle 11B, a CF card receptacle 11C, and a micro type hard disk receptacle 11D, so as to provide the function of expanding the memory.

Accordingly, the battery box of the present invention is integrated to have the MP3 propagation function, the FM audio receiving function, the hand-free receiver, the digital recording function, and the dialogue recording function, thereby providing utility and diverse functions. In addition, the battery box can be adapted to expand the memory.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A multifunctional battery box of a mobile telephone comprising:
a battery set;
a control circuit board, provided with a microprocessor, a digital audio processor, and a memory, thereby forming a function of a hand-free receiver, a MP3 propagation function, a FM audio receiving function, a digital recording function, and a dialogue function;
a push button set, mounted on a surface of said battery box, and connected to said microprocessor;
a microphone and a horn, mounted on said surface of said battery box, for providing input and output of an audio signal; and
a display, mounted on said surface of said battery box.

2. The multifunctional battery box of a mobile telephone in accordance with claim 1, wherein said display is a digital display or a liquid crystal display.

3. The multifunctional battery box of a mobile telephone in accordance with claim 1, further comprising a memory expansion insertion slot for allowing a selective insertion of a memory card or cassette, so as to expand storage contents.

4. The multifunctional battery box of a mobile telephone in accordance with claim 1, further comprising a USB receptacle mounted on said surface of said battery box, for connection with a computer to download MP3 music into said battery box.

5. The multifunctional battery box of a mobile telephone in accordance with claim 4, wherein said USB receptacle mounted on said surface of said battery box is a RS232 receptacle, for connection with a computer.

6. The multifunctional battery box of a mobile telephone in accordance with claim 1, further comprising a channel selection button mounted on said surface of said battery box, and a FM modulation integrated circuit mounted on said control circuit board.

7. The multifunctional battery box of a mobile telephone in accordance with claim 1, wherein said memory includes a flash memory, a program memory, and a read-only memory.
